(19) United States
(12) Patent Application Publication
(10) Pub. No.: US 2023/0228381 A1
(43) Pub. Date: Jul. 20, 2023

(54) VALVE UNIT, ON-TANK VALVE AND GAS PRESSURE TANK SYSTEM, IN PARTICULAR FOR FUEL CELL SYSTEMS, AND METHOD FOR DETECTING A LEAKAGE

(71) Applicant: Argo GmbH, Gräfelfing (DE)

(72) Inventor: Jan ANDREAS, Wesel (DE)

(21) Appl. No.: 18/001,227

(22) PCT Filed: Jun. 10, 2021
(86) PCT No.: PCT/EP2021/065626

§ 371 Date: Dec. 8, 2022

(30) Foreign Application Priority Data
Jun. 10, 2020 (DE) 10 2020 207 253.1

(51) Int. Cl. F17C 13/04; F17C 13/02; H01M 8/04082

(52) U.S. Cl. CPC F17C 13/04; F17C 13/025; F17C 13/026; H01M 8/04201; F17C 2205/0326; F17C 2205/0329; F17C 2205/0332; F17C 2205/0335; F17C 2205/0338; F17C 2205/0341; F17C 2205/0385; F17C 2205/0394; F17C 2221/012; F17C 2223/036; F17C 2250/034; F17C 2250/0626; F17C 2250/0631; F17C 2250/0678; F17C 2250/0684; F17C 2260/036; F17C 2270/0178; F17C 2270/0184; F17C 2270/0754

(57) ABSTRACT

The present disclosure relates to a valve unit for a fuel supply system which is preferably adapted to supply a fuel cell system with fuel, comprising: at least one temperature detector, at least one pressure detector, and a safety valve integrated into a line section, wherein the safety valve can be adjusted between an open position, in which gas is able to flow through the line section, and a closed position, in which gas is not able to flow through the line section, wherein the temperature detector and the pressure detector are so disposed that they are able to detect a temperature and a pressure of the gas flowing through the line section in a state in which the gas is present at the closed safety valve in such a manner that it exerts pressure. The present disclosure relates further to an on-tank valve which can have all the features described in relation to the valve unit and differs from the valve unit only in that it is able to be mounted directly on a gas pressure tank. The present disclosure relates further to a gas pressure tank system for storing fuel, comprising: at least one gas pressure tank and a valve unit. Finally, the present disclosure relates to a method for detecting a possible leakage in a fuel supply system, and to a valve assembly.

### BACKGROUND

### Technical Field

The present disclosure relates to a valve unit, to an on-tank valve and to a gas pressure tank system having a valve unit of the same type and/or an on-tank valve of the same type, wherein said valve unit, on-tank valve and gas pressure tank system can preferably be used in fuel supply systems which, for example, supply fuel cell systems or applications of fuel cells with fuel, in particular with hydrogen. The present disclosure relates further to a method for detecting a leakage, in particular in a gas pressure tank system, and to a valve assembly.

### Description of the Related Art

With the increasing pressure from the public on the automotive industry and politics to develop and provide environmentally friendly drive technologies, the much discussed phasing out of fossil fuels, climate change and the associated greater willingness of industry to back cleaner technologies, research has increasingly been carried out in recent years in the field of alternative drive concepts. These include on the one hand alternative fuels, such as hydrogen, ethanol or natural gas, and on the other hand alternative drives, such as hybrid and electric engines.

Major advances have here been made inter alia in the field of fuel cell technology or hydrogen drive technology. Thus, many childhood diseases which initially existed have been able to be eliminated and factors which cause costs have been able to be eliminated or at least reduced. A component which continues to cause high costs is platinum, which has hitherto been used as a catalyst. However, here too, researchers and engineers have achieved success with extremely thin platinum layers, while at the same time cobalt is already being successfully experimented with as a platinum substitute. Furthermore, it has been possible to substantially reduce the size of fuel cell systems. While the NECAR 5 fuel cell system, for example, still filled the entire underfloor, the required technology is today concentrated only in the space beneath the bonnet.

The mentioned examples show that fuel cell systems as an alternative drive technology have in recent years reached the series-production stage. The demand for safe tank systems for the necessary fuel or the fuel gas is growing accordingly. On the one hand, the fuel cell can here be supplied directly with hydrogen, alternatively it is also possible to supply the fuel cell with hydrogen indirectly via a reformer. For this purpose, a reformer obtains hydrogen from stored natural gas, which is a hydrogen-rich compound, and feeds it to the fuel cell, which generates heat and power by an electrochemical reaction.

In order to be able to store sufficient fuel or fuel gas in a vehicle or transport means, in particular in a passenger car, which is necessary in order to ensure a satisfactory range of the vehicle, the trend in recent times has been away from the hitherto established design with a pressure vessel towards high-pressure vessel units which comprise a plurality of individual vessels.

Thus, DE 10 2018 116 090 A1 describes a high-pressure vessel unit 10 having a box-like case 22, a plurality of cylindrical vessels 18 which are arranged in a row inside the case 22, wherein each vessel includes an opening 30B at an end portion on one side of the vessel 18 in the axial direction, a coupling member 20 which connects the openings 30B in order to couple the plurality of vessels 18 with one another, and which includes a flow passage which connects the interiors of the plurality of vessels 18 with one another so that they communicate. The described high-pressure vessel unit 10 further has a lead-out pipe 32 which leads from the coupling member 20 through a through-hole 46A formed in the case 22 to the exterior of the case 22, wherein there is connected to the lead-out line 32 a valve 34 which can open and close the flow passage.

Such high-pressure vessel units have the advantage that, owing to their compactness, in particular their small overall height, they can easily be disposed on the vehicle underside of a floor panel 16 (see FIG. 1) which forms the floor of the passenger compartment. It is accordingly possible to construct electric vehicles which on the one hand are supplied with energy (power) by a battery or alternatively are provided with energy (power) by a fuel cell system on the basis of the same vehicle concept.

Accordingly, in the case of a battery-driven electric vehicle, the battery can be installed in the region beneath the passenger compartment, in which the high-pressure vessel unit 10 is accommodated in the case of a hydrogen-driven electric vehicle.

Owing to the above-mentioned advantages and the continual further development of fuel cell systems, such systems have also found their way into other fields, or are about to do so. Thus, DE 10 2007 001 912 A1, for example, describes a fuel supply system for a fuel cell system for use in an aircraft. The described fuel supply system 110 has a fuel tank 112, a feed line 114 which connects the fuel tank 112 to an inlet 116 of a fuel cell 118, a tank isolation valve 128 disposed in the feed line 114, a removal line 146 which connects an outlet 120 of the fuel cell 118 to an unpressurized region of the aircraft and/or the outer atmosphere, and a sensor 144 for detecting an electrical voltage in the fuel cell 118.

Such fuel supply systems can be used in aircraft for generating the electrical energy that is required on board an aircraft. For example, it is conceivable to replace the generators which are currently used for the on-board power supply and which are driven by the main engines or the auxiliary turbine with a fuel cell system. The overall efficiency of the engines could thereby be increased further. Moreover, such a fuel cell system could also be used for the emergency power supply of the aircraft and replace the ram air turbine (RAT) hitherto used as the emergency power unit.

Fuel supply systems can also be used for supplying aerial drones, such as, for example, transport drones or also passenger drones, for supplying the electrical drives of the rotors. In this manner it is possible to dispense with the heavy batteries which currently limit the range and flying time and also the transportable load of such drones.

However, all the above-described fields of application for fuel supply systems have one problem in common: the fuel supply systems must meet high safety standards and also high demands in terms of availability, in particular in the field of passenger transport such as aircraft, aerial drones or motor vehicles. The integrity of the gas pressure tank must be ensured at all times, in particular in the event of an emergency such as, for example, a fire on board an aircraft, in the event of an accident of a vehicle or fire of a vehicle, and the uncontrolled escape of the fuel or fuel gas must be prevented.

### BRIEF DESCRIPTION

The object underlying the disclosure is, in principle, to provide a valve unit, an on-tank valve and a gas pressure tank system which are capable on the one hand of meeting the above-described high safety standards and high demands in terms of availability, while at the same time a simplification of the respective components, in particular of a fuel supply system equipped therewith, is achieved and the production costs and also the maintenance costs (outlay in terms of maintenance) can thus be reduced. A further object underlying the disclosure is in particular to provide a valve unit, an on-tank valve and a gas pressure tank system by means of which it is possible in a simple and reliable manner to detect a leakage or a gas leak in a system (the connected or comprised components). Accordingly, it is also an object of the present disclosure to provide a method for detecting a possible leakage. The present disclosure further provides a valve assembly by means of which, in compact design, a safety valve can be provided, in which the safety valve or main valve remains in an open position after it has been actuated, in particular manually actuated, once, even if an actuating pulse is interrupted or there is a leakage.

The mentioned objects are achieved by a valve unit according to claim 1, an on-tank valve according to claim 2, a gas pressure tank according to claim 25, a gas pressure tank system according to claim 27 and a fuel supply system according to claim 29. The objects are further achieved by a method for detecting a possible leakage according to claim 30 and by a valve assembly according to claim 34.

Preferred further developments of the disclosure are indicated in the dependent claims, wherein the subject matter of the claims relating to the valve unit or to the on-tank valve can be used within the scope of the gas pressure tank, the gas pressure tank system, the fuel supply system, in the method for detecting a possible leakage and also in the valve assembly, and vice versa.

One of the fundamental ideas of the present disclosure is to provide at least one temperature detector, at least one pressure detector, and a safety valve integrated into a line section, wherein the safety valve can be adjusted between an open position, in which gas is able to flow through the line section, and a closed position, in which gas is not able to flow through the line section, and the temperature detector and the pressure detector are so disposed that they are able to detect a temperature and a pressure of the gas flowing through the line section in a state in which the gas is present at the closed safety valve in such a manner that it exerts pressure, in other words in a state in which the safety valve is closed, and the valve unit is further adapted to conduct a tightness test of the line section on the basis of the detected temperature and pressure values.

According to one aspect of the present disclosure, a valve unit, in particular a gas handling unit, which is preferably usable for a fuel supply system or a fire extinguishing system, wherein the fuel supply system is preferably adapted to supply a fuel cell system with fuel, in particular hydrogen, has at least one temperature detector, at least one pressure detector, and a safety valve integrated into a line section, wherein the safety valve can be adjusted between an open position, in which gas is able to flow through the line section, and a closed position, in which gas is not able to flow through the line section, wherein the temperature detector and the pressure detector are so disposed that they are able to detect a temperature and a pressure of the gas flowing through the line section in a state in which the gas is present at the closed safety valve in such a manner that it exerts pressure.

In other words, the temperature detector and the pressure detector are so disposed or positioned that they are able to detect the temperature and the pressure of the gas before the safety valve, i.e., upstream, in the direction of flow, in particular the outflow direction of the gas from a gas pressure tank or a gas pressure tank system.

The valve unit of the present disclosure can further be used for high-pressure applications, such as, for example, breathing apparatuses in diving, aeronautical applications, drones, energy supply in general, and the like.

The valve unit is further adapted to conduct a tightness test of the line section, in particular of a gas pressure tank system connected to the line section, on the basis of the detected temperature and pressure values, in particular in the closed state of the safety valve.

It is further preferred if the valve unit is able to open or close a main supply line of a fire extinguishing system which uses nitrogen (N₂) as the extinguishing agent.

Such a valve unit, in particular gas handling unit, can be used in a fuel supply system of a vehicle, in particular of an electric vehicle, for supplying a fuel cell system which serves as the power generator for the electric motor of the vehicle with fuel, in particular with hydrogen.

Within the scope of the present disclosure, the term “vehicle” or “transport means” or other similar terms as used hereinbelow includes motor vehicles in general, such as passenger cars including sports utility vehicles (SUVs), buses, lorries, various commercial vehicles, water vehicles including various boats and ships, aircraft and the like, hybrid vehicles, electric vehicles, plug-in hybrid electric vehicles, hydrogen vehicles and other alternative vehicles (e.g., fuels which are obtained from resources other than petroleum). As mentioned here, a hybrid vehicle is a vehicle with two or more energy sources, for example petrol-driven and at the same time electrically driven vehicles.

Furthermore, the term “fuel” is to be understood within the scope of the present disclosure as meaning a medium or fluid which serves as an energy store. On the one hand it can be a fuel whose chemical energy is converted into mechanical energy by combustion in internal combustion engines, such as, for example, combustion engines or gas turbines, on the other hand it can be, for example, hydrogen which, in a fuel cell (galvanic cell), continuously carries out a chemical reaction and thereby generates electrical energy or converts the chemical energy into electrical energy. However, it is also possible to burn hydrogen in special fuel engines, whereby hydrogen can also be used as a fuel. The fuel can be gaseous or liquid. Pressure tanks have in the meantime also been developed in which hydrogen is stored in both forms, that is to say gaseous and liquefied, so-called transcritical storage.

It can further be advantageous if the valve unit is configured in the form of an on-tank valve for attachment to a gas pressure tank, in particular a hydrogen tank, which is preferably adapted to supply a fuel cell system with fuel, in particular hydrogen.

The on-tank valve can have all the features described in relation to the valve unit and differs therefrom only in that it is able to be mounted directly on a gas pressure tank.

In this manner it is possible on the one hand to dispense with unnecessary pipework, on the other hand the components provided in the valve unit, such as, for example, the protection valve, can thereby be situated as close as possible to the gas pressure tank, in particular the outlet opening thereof. As a result, in the event of a leakage in the fuel supply system, for example, a further escape of fuel can be avoided by the protection valve. By attaching the valve unit directly to the gas pressure tank in the form of the “on-tank valve” (OTV), the amount of fuel, in particular hydrogen, that is lost can thus be kept to a minimum.

An on-tank valve has the further advantage that, in the event of an accident in which, for example, the following pipework of the fuel supply system is damaged, in particular is separated or broken away from the gas pressure tank, at least the components provided in the on-tank valve continue to be present on the gas pressure tank, whereby it can be ensured that at least the desired emergency functions of the valve unit can be maintained.

It is further advantageous if the valve unit, in particular the on-tank valve, has a connecting piece which is adapted to be able to be screwed into a gas pressure tank, in particular into a connecting piece/outlet opening of the gas pressure tank.

The valve unit can thereby be attached in a simple and secure manner to standardized gas pressure tanks and quickly detached from the gas pressure tank for maintenance work or testing.

According to one embodiment of the valve unit of the present disclosure, the line section is provided such that, in the state in which it is attached to the gas pressure tank, it projects into the gas pressure tank and has an open end on the side facing the gas pressure tank.

It is further preferred that there is provided a sensor pipe which extends separately from the line section at least in part and which is configured such that it projects into the gas pressure tank and at the end of which the temperature detector and/or the pressure detector is/are preferably provided.

The temperature detector and the pressure detector can on the one hand be configured as a thermocouple or a strain gauge (DMS), respectively, on the other hand they can be configured as a complete sensor, in particular as a smart sensor, which outputs, for example, sensor signals which have already been processed. That is to say, a smart sensor is able to output control and/or regulating signals directly without a controller. In other words, carry out decentralized control and/or regulation.

It is further advantageous if an excessive flow valve and/or throttle valve is provided before the safety valve, which is preferably a pulse-controlled valve, in particular a solenoid valve, in the direction of flow S1, in particular in the outflow direction of the gas or fuel from the gas pressure tank in the direction towards a consumer, in particular in the direction towards the fuel cell.

Within the scope of the present disclosure, “pulse-controlled valve” is to be understood as meaning that the valve is actuated by an external pulse, or an external application of force. The pulse can be introduced into the valve, for example, in the form of a magnetic force by a solenoid valve. However, it is also possible to actuate or control the valve pneumatically, hydraulically or by an optical signal. It is further advantageous if a filter is disposed before and/or after the safety valve in the direction of flow S1.

The components, in particular valves, provided in the valve unit can thereby be protected from contaminants present in the gas or fuel and thus the lifetime of the individual components can be increased and the outlay in terms of maintenance of the valve unit can be reduced.

Advantageously, a pressure regulating valve can preferably be disposed after the safety valve in the direction of flow S1, that is to say provided downstream of the safety valve, and can be adapted to reduce and/or to regulate a gas pressure tank pressure P₁ to an operating pressure P₂ of a consumer that is to be supplied with the gas or the fuel.

Within the scope of the present disclosure, “gas pressure tank pressure P₁” is to be understood as being the pressure which is present, for example, in a closed gas pressure tank which is filled at least partially with a fuel. However, it can also be the pressure which is present at the safety valve and is fed by a plurality of pressure tanks which are combined to form a gas pressure tank system.

In conventional gas pressure tanks, the pressure of the stored fuel, in particular of the stored hydrogen, can be up to 900 bar. Accordingly, the protection valve must withstand a pressure of up to 900 bar, preferably up to 700 or 875 bar, and in particular be able to close and open against a pressure of up to 900 bar, preferably 700 or 875 bar.

Furthermore, within the scope of the present disclosure the term “operating pressure P₂” is to be understood as being the pressure which is provided by the valve unit to a consumer or a plurality of consumers downstream of the valve unit. Accordingly, the operating pressure P₂ is determined by the consumer that is to be supplied with fuel by the valve unit or by the fuel supply system. If the consumer is a fuel cell, for example, the operating pressure P₂ can be 10 bar.

It is further advantageous if the valve unit has a first excess pressure device, in particular an excess pressure valve, which is adapted to limit the operating pressure P₂ regulated by the pressure regulating valve to a preset limit value. In the case of a fuel cell system, for example, the operating pressure can be limited to 20 bar, whereby it is ensured that, in the event of an anomaly/fault of the pressure regulating valve of the valve unit, the downstream consumer, in particular the fuel cells, are not damaged by a gas pressure that is too high.

It is further preferred if there is provided a second excess pressure device, in particular a rupture disk, which is adapted to protect a gas pressure tank connected to the valve unit from excess pressure.

It is advantageous if the second excess pressure device is connected to the gas pressure tank or the gas pressure tanks not via the line section via which the protection valve is connected to the gas pressure tank or the gas pressure tank system, but via a separate pipeline.

If a separate pipeline is provided for this purpose, said pipeline can also be used to apply the gas pressure tank pressure P₁ present in the gas pressure tank(s) to the pressure detector.

In this manner it can be ensured that, for example in the event of a malfunction of a refueling system, which introduces an inadmissibly high pressure on refueling or filling the gas pressure tank or the gas pressure tank system, the individual gas pressure tanks are not damaged, that is to say are not filled beyond their permissible maximum pressure. If the pressure in the gas pressure tanks reaches a predetermined maximum pressure during faulty refueling, the excess pressure device opens a fluid connection to a discharge port and releases the gas or the fuel to the environment. This can take place, for example, by rupturing of the rupture disk, whereby it is further ensured that the excess pressure device remains in the open state.

It is further preferred that the valve unit has a thermal pressure relief device which is adapted, at a predetermined temperature limit value, to release the fuel stored under pressure in a gas pressure tank connected to the valve unit to the surrounding air via a discharge port.

The thermal pressure relief device can preferably have an actuating member which, when the predetermined temperature limit value is reached, opens, in particular irreversibly opens, a valve of the pressure relief device, wherein the actuating member is preferably formed by a glass body which ruptures when the predetermined temperature limit value is reached and thereby enables actuation of the valve, or by a liquid which is preferably integrated into the gas pressure tank and which, through expansion of its own volume, when the predetermined temperature limit value is reached, triggers a mechanism, in particular a piston system, which actuates or opens the valve of the pressure relief device.

Alternatively or in addition, the possibility can be provided that the pressure relief device (109) is instructed and/or actuated to open by an external pulse, in particular an external control command, wherein the external pulse can be sent by an external controller.

According to a further embodiment of the present disclosure, the temperature detector and the pressure detector, in particular measurement points of the temperature detector and/or of the pressure detector, are disposed upstream of the safety valve in a direction of flow S1 of the gas flowing through the line section, wherein preferably at least the measurement points are disposed inside a gas pressure tank.

In this manner it is possible, by means of the safety valve, to confine the fuel stored, for example, in a gas pressure tank in the gas pressure tank, or to prevent the fuel from flowing out of the gas pressure tank, and thus to create a static state in the gas pressure tank or the gas pressure tank system.

This makes it possible to monitor the gas state of the fuel stored in the gas pressure tank or the gas pressure tank system over a specific time period and thereby determine a stability of the gas state. If the gas state in the gas pressure tank or the gas pressure tank system, taking into consideration external influences such as, for example, ambient temperature, sun exposure and the like, is constant over the specified time period, it can be assumed that the system is intact, that is to say there is no leakage or no gas leak.

It is further preferred that the valve unit has a control device which is adapted to receive signals, in particular measurement signals of the temperature detector and/or of the pressure detector and/or of external sensors and/or of a temperature sensor provided on the gas pressure tank, to process those signals and to output corresponding control signals, in particular to the safety valve and/or the pressure regulating valve and/or the thermal pressure relief device.

By integrating a control device directly into the valve unit it is possible on the one hand to create an autonomous system which controls or regulates itself independently without the involvement of an external controller, such as the controller of a fuel cell system or of a vehicle. This further has the advantage that it is possible to dispense with a costly cable harness which connects the individual components of the valve unit with an external controller. By contrast, it is simply necessary to connect the control device to an external controller for signaling, if desired.

In this manner, a vehicle controller, for example, can send a start signal to the control device, which then initiates and controls all the necessary steps for starting operation of the downstream fuel cell system.

It is further advantageous if the control device is adapted, in order to conduct a tightness test of the line section, in particular of a gas pressure tank system connected to the line section, to bring the safety valve into a closed position and then, for a predetermined time period, to determine a plurality of temperature and pressure values of the gas or fuel present at the safety valve by means of the temperature detector and of the pressure detector, and to conduct the tightness test on the basis of the determined temperature and pressure values.

It is further advantageous if the temperature and pressure values are determined inside the connected gas pressure tank and/or, preferably, at a plurality of measurement points inside the connected gas pressure tank system.

For the tightness test, the plurality of detected temperature and pressure values are preferably compared with one another in order to determine a characteristic value of the stability and/or a trend. If the characteristic value of the stability and/or the trend lies within a predetermined range, the line section, in particular the gas pressure tank system connected to the line section, is tight. That is to say, there is no leakage.

Within the scope of the present disclosure, the term “trend” defines a change in the detected temperature and/or in the detected pressure that lasts at least for a specific time period. The characteristic value of the stability, on the other hand, provides information about the stability or consistency of the detected temperature and/or of the detected pressure over a predetermined time period.

It is further preferred that the valve unit has a communication device, which can advantageously be a wireless communication device using infrared, radiocommunication, Bluetooth or wireless local area network (WLAN), which is adapted to send/transmit to external clients data or information detected by the valve unit, such as pressures (P₁, P₂), temperatures, opening and closing cycles and/or open and closed positions of the individual valves, in particular of the safety valve and/or of the pressure regulating valve.

The integration of a communication device, in particular a wireless communication device, makes it possible that, for example during a refueling operation of the gas pressure tank system by a refueling system, the refueling system communicates with the valve unit before the start of the refueling operation in order to query the integrity of the gas pressure tank system or of the fuel supply system. If the refueling system establishes that the gas pressure tank system to be refueled has a defect and/or a leakage, for example, the refueling system can refuse the start of refueling or terminate the refueling operation when refueling has already started.

It is further advantageous if the communication device is adapted to be able to receive control commands, preferably for the control device, from external clients, such as, for example, an external controller/main controller of a vehicle, an emergency control system which can be operated by the fire brigade, the police or other auxiliary forces.

It is thereby made possible that, for example in the event of an accident or of a fire of the vehicle, the driver, before he leaves the vehicle, brings the fuel supply system, in particular the gas pressure tank system, into a secured state and, if necessary, empties the individual gas pressure tanks via the discharge port A3, wherein the emptying operation takes place in a controlled manner by means of the thermal pressure relief device. For this purpose, the thermal pressure relief device can have a pulse-controlled valve, by means of which the pressure relief device can be controlled, in particular opened, remotely, for example via radiocommunication.

The expression “in a controlled manner” is to be understood as meaning that the emptying of the gas pressure tank or of the gas pressure tanks takes place at a predetermined flow rate which is so chosen that on the one hand emptying does not take place too quickly, so that supercooling of the gas pressure tank, which could possibly lead to damage to the gas pressure tank, is prevented, but on the other hand it is ensured that emptying takes place sufficiently quickly, so that, in the event of a fire, for example, it can be ensured that emptying takes place within a time period of usually from 3 to 5 minutes, so that the integrity of the gas pressure tank can be ensured until the gas pressure tank is empty. The time for emptying the gas pressure tank is dependent to a significant extent on its size.

It is further preferred that the control device is adapted to communicate by means of the communication device with a refueling system in order to exchange information with the refueling system, wherein the information is selected from the group of: gas pressure tank pressure P₁, gas pressure tank temperature T₁, filling speed (l/min) and tightness (there is no leakage) of the gas pressure tank, of the valve unit and/or of the fuel supply system.

In this manner it can be ensured, as already explained above, that refueling of a damaged gas pressure tank or gas pressure tank system is not carried out.

It is further advantageous if the valve unit has a temperature-control device which is adapted to condition, in particular to cool and/or to heat, the gas or the fuel flowing through the valve unit, in particular after it has been reduced to the operating pressure P₂ by the pressure regulating valve, to a predetermined operating temperature T_{A}.

The operating temperature T_{A} is likewise defined by the consumer, such as, for example, the fuel cell, that is to be supplied with gas or fuel. The operating temperature T_{A} and also the operating pressure P₂ can be dependent on the load state of the consumer. For example, in the case of a cold start of the downstream fuel cell system, start-up can be effected with an increased operating temperature in order to bring the fuel cell system, in particular the fuel cells, to operating temperature more quickly.

For this purpose, the temperature-control device can have a heating and/or cooling register, wherein the heating register is fed, for example, by waste heat of the fuel cell system. For the cold start, the temperature-control device can further be equipped with an electrical heater in the form of heating coils.

It is further preferred if the valve unit is additionally equipped with a leakage detection unit (sniffer system) which is adapted to test or to monitor the tightness of at least one component of the valve unit, wherein the component is selected from the group of: safety valve, excessive flow valve, filter, pressure regulating valve, first excess pressure device, second excess pressure device, thermal pressure relief device, temperature-control device, temperature detector and/or pressure detector.

It is thereby possible to continuously test and to log the tightness (gas tightness), that is to say the absence of a leakage, and, in the event of a leakage, to proceed accordingly by, for example, closing off or emptying specific components of the valve unit or of the fuel supply system.

The leakage detection unit can be configured such that there is provided in the valve unit a so-called collection chamber in which there is disposed a leakage sensor (sniffer) or gas sensor which is able to detect very small amounts of gas. The individual components provided in the valve unit, such as, for example, the safety valve and/or the pressure regulating valve, are channeled into the collection chamber, which means that the respective components are connected by a fluid-carrying channel to the collection chamber, whereby, in the event of a leakage of the respective component, the escaping gas can flow or be guided into the collection chamber and is detected there by the gas sensor. In this manner, a plurality of interfaces or components can be checked or monitored for their tightness.

It is further advantageous if the valve unit has an orientation detection unit which is adapted to detect the absolute geometric orientation in space (in three-dimensional space) of the valve unit, in particular of at least one gas pressure tank connected to the valve unit, wherein the orientation detection unit has at least one sensor selected from the group of: accelerometer, gyroscope and geomagnetic sensor.

It is preferred that the control device is adapted, on the basis of an orientation of the valve unit determined or detected by the orientation detection unit, to choose a discharge port by means of which emptying of a gas pressure tank in a predetermined safe spatial direction is possible.

For this purpose, the valve unit can have a plurality of discharge ports which can each be opened or closed by a valve, in particular a solenoid valve, that is provided. Discharge pipes can advantageously be provided at each of the discharge ports, which are oriented in different spatial directions in order to discharge the fuel in a desired or advantageous spatial direction in the event of an accident of the vehicle.

The discharge pipes are preferably so disposed that the fuel that is released cannot damage any components of the vehicle, in particular of the fuel supply system, that are relevant in terms of safety and also does not obstruct access to the vehicle. Experience has shown that, according to the position of the vehicle, which, for example in the event of an accident, may be lying on its side, a discharge pipe is chosen that releases the fuel upwards, that is to say in the vertical direction, so that access to the vehicle from the side, in particular for rescue parties, is ensured.

According to a further embodiment of the present disclosure, the valve unit has an electrical and/or electronic interface by means of which the valve unit can be electrically and/or electronically conductively connected to external components/devices, wherein the external components/devices are selected from the group of: energy source such as, for example, a battery, controller/main controller of a vehicle, a controller of a fuel cell, and the like.

In this manner it is possible, for example, as already described above, for an external vehicle controller to access the parameters such as pressures and/or temperatures detected by the valve unit without being directly connected to the respective sensors by cable, which drastically reduces the outlay in terms of cabling.

It is further advantageous if the valve unit has a connection region which is adapted to connect external components/devices electrically and/or electronically to the valve unit, wherein the external components/devices are selected from the group of: external sensors such as, for example, the temperature sensor provided on the gas pressure tank, on-tank valves and the like. The electrical and/or electronic interface can be implemented in the form of a CAN bus, for example.

This connection region differs from the previously mentioned electrical and/or electronic interface in that it has, according to requirements, a plurality of connecting terminals by means of which the individual external components, which, however, preferably belong to the fuel supply system or to the gas pressure tank system, can be connected to the valve unit. The sensor signals which are transmitted in this manner to the valve unit can then be forwarded in a bundle to one or more external controllers by the electrical and/or electronic interface.

It is further advantageous if the control unit of the valve unit is adapted to detect and/or to log refueling cycles of at least one gas pressure tank connected to the valve unit, and/or the control unit is adapted to terminate or not even start refueling of at least one pressure tank connected to the valve unit if a leakage is detected, in particular by means of the leakage detection unit.

It is further preferred if the valve unit has a power generation device, wherein the power generation device has at least one converter which is adapted to convert flow energy, in particular flow energy of the fuel flowing into the valve unit, into mechanical energy, in particular rotational energy (or rotation energy), and a generator which is adapted to convert the mechanical energy into electrical energy, in particular power.

As already described hereinbefore, the fuel, in particular the hydrogen, is stored under an extremely high pressure in the gas pressure tank or in the gas pressure tanks; the pressure can be up to 1000 bar. A correspondingly large amount of potential energy (internal energy; kinetic energy per unit volume) is stored in the gas pressure tank or the gas pressure tanks, which, on removal of the fuel from the individual gas pressure tank, is converted into kinetic energy or flow energy. This kinetic energy or flow energy produced when the fuel flows out of the gas pressure tank or the gas pressure tanks during operation of the downstream consumer can be converted by the power generation device into electrical energy, in particular power. The electric power thereby generated can, for example, be fed to a battery and temporarily stored therein. As required, the electric power so obtained can be used, for example, for conditioning the fuel, in particular the hydrogen, for operation of the downstream consumer.

It is further advantageous if the converter is configured in the form of a turbine, wherein the turbine can preferably have a plurality of blades on a hub, one or more wind wheels and the like, and the converter, by converting the flow energy or the internal energy of the flowing fuel into mechanical energy, sets a drive shaft in rotation, wherein the generator is preferably driven by the drive shaft of the converter and thereby generates electric power.

The power generation device can be integrated directly into the valve unit, in particular a valve block of the valve unit, or can be disposed upstream of the valve unit, that is to say configured as a separate assembly.

It is further advantageous to dispose the power generation device before the pressure regulating valve of the valve unit, in particular directly at the entry of the valve unit.

It is further preferred that the converter, in particular the turbine, controls or regulates the drop in internal energy, or the delta P (pressure of the fuel before the converter—pressure of the fuel after the converter), in dependence on the pressure present in the gas pressure vessel. In other words, if a high pressure is present in the gas pressure tank, the converter can reduce a high delta P (internal energy), while if the pressure of the fuel in the gas pressure vessel approaches the operating pressure of the downstream consumer, the delta P must be reduced in order to be able to ensure a sufficient operating pressure.

The present disclosure relates further to a gas pressure tank having a connecting piece into which a valve unit as described above or an on-tank valve described above is able to be introduced. The valve unit and/or the gas pressure tank is optionally provided with seals in order to position the valve unit in a gas-tight manner inside the connecting piece of the gas pressure tank.

Gas pressure tanks of the same type are usually configured as hollow bodies which are formed of a multilayer laminate, in particular a multilayer plastics laminate. The plastics laminate can preferably be provided with a reinforcing fiber material, for example with carbon fibers or with glass fibers, in order to increase its stability. The connecting piece is introduced into this laminate and usually provided with an internal thread into which a mating thread which is provided on the connecting piece of the valve unit is able to be screwed in order to attach the valve unit, in particular the on-tank valve, to the gas pressure tank, preferably in the gas pressure tank.

It is advantageous if at least one sensor, such as, for example, a temperature or voltage sensor (strain gauge (DMS)), is embedded into the laminate of the gas pressure tank. In this manner, additional information about the integrity of the gas pressure tank can be collected and forwarded to the valve unit.

The present disclosure relates further to a gas pressure tank system for storing fuel, in particular hydrogen, which is preferably adapted to supply a fuel cell system with fuel, in particular hydrogen, having: at least one gas pressure tank, preferably the gas pressure tank described above having an integrated connecting piece, and a valve unit, preferably the valve unit described above, and/or at least one on-tank valve, wherein the on-tank valve is preferably the on-tank valve described above.

In this manner, a plurality of individual gas pressure tanks can be combined to form an assembly, whereby the individual gas pressure tank can be made smaller, in particular smaller in diameter, and thus the gas pressure tank system, in particular the gas pressure tank assembly, can more easily be accommodated in a vehicle. However, it is also possible to construct the gas pressure tank system with only one gas pressure tank. The number and size of the gas pressure tank or gas pressure tanks can be selected in dependence on the requirements and available space of the respective vehicle in which the gas pressure tank system is to be implemented.

It is further preferred if the gas pressure tank system has at least two gas pressure tanks which are each provided with an on-tank valve and are connected together by means of a valve unit so as to carry gas, so that a fuel supply system is able to be supplied with a fuel which is stored under high pressure in the two gas pressure tanks.

The two on-tank valves can be provided with a minimal number of components/functions, which serve mainly for ensuring emergency functions such as shutting off the respective gas pressure tank in the event of a leakage in the gas pressure tank system or in the fuel supply system. These can include inter alia the provision of an excessive flow valve, whereby it can be ensured that, in the event of an accident, the fuel can be released in a controlled manner, even though the downstream fuel supply system is no longer intact, in particular has leakages.

On the other hand, such a gas pressure tank system has the advantage that the further functionalities, such as control, interfaces, pressure regulation, pressure limiting and the like, can be provided together in the valve unit for all the gas pressure tanks, whereby the number of components can be reduced, the outlay in terms of cabling can be reduced, and thus the production costs and also the maintenance costs can be reduced.

The present disclosure relates further to a fuel supply system which is preferably adapted to supply a fuel cell system with fuel, in particular hydrogen, wherein the fuel supply system has the valve unit described above and optionally the gas pressure tank system described above.

The present disclosure relates further to a method for detecting a possible leakage, a gas leak, in a fuel supply system, in particular a gas pressure tank system for storing fuel, in particular hydrogen, which is preferably adapted to supply a fuel cell system with fuel, in particular hydrogen. The method has the following steps:
closing a safety valve integrated into a line section, wherein the safety valve can be adjusted between an open position, in which gas is able to flow through the line section, and a closed position, in which gas is not able to flow through the line section,
detecting a temperature T₁ and a pressure P₁ of the gas flowing through the line section in a state in which the gas is present at the closed safety valve in such a manner that it exerts pressure,
conducting a tightness test of the line section, in particular of a gas pressure tank system connected to the line section, on the basis of the detected temperature and pressure values.

It is advantageous if a plurality of temperature and pressure values are determined within a predetermined time period, wherein the temperature and pressure values are preferably determined inside a connected pressure tank and/or at a plurality of measurement points inside a connected gas pressure tank system.

The plurality of measurement points can be so chosen that they are provided inside a plurality of pressure tanks and/or at line junctions and/or valves of the gas pressure tank system.

It is further advantageous if the plurality of determined temperature and pressure values are compared with one another in order to determine a characteristic value of the stability and/or a trend, if the characteristic value of the stability and/or the trend lies within a predetermined range, the line section, in particular the gas pressure tank system connected to the line section, is tight. In other words, there is no leakage.

According to a further embodiment of the present disclosure, the predetermined range (tolerance range) for the characteristic value of the stability and/or the trend is determined on the basis of influencing parameters from the group of: outside temperature, starting temperature, starting pressure, whether a refueling or emptying operation is taking place, sun exposure, gas pressure tank size, refueling or emptying speed and the like.

The present disclosure relates further to a valve assembly of a valve unit, in particular of the valve unit described above, which is preferably used for a fire extinguishing system which preferably uses nitrogen (N₂) as the extinguishing agent, having: a main supply line, a main valve integrated into the main supply line, wherein the main valve is adjustable between an open position, in which gas is able to flow through the main supply line, and a closed position, in which gas is not able to flow through the main supply line, and a pressure regulating valve which is adapted to reduce and/or to regulate a pressure of the gas flowing through the main supply line, wherein the main valve is able to be brought or switched, in particular indirectly, into the open position by means of a pulse-controlled actuating valve, and the valve assembly is configured such that the main valve remains in the open position even if actuation by the pulse-controlled actuating valve is released and/or interrupted.

Within the meaning of the present disclosure, the term “released” is to be understood as meaning that the actuating valve is released actively or inactively, for example by voltage drop. On the other hand, the term “interrupted” within the meaning of the present disclosure means that a pressure of compressed air or control air that is used to open, in particular to permanently open, the main valve decreases, for example owing to a leakage.

According to a further embodiment of the present disclosure, the main valve is able to be brought into the open position by actuation of the pulse-controlled actuating valve, in particular manual actuation of the actuating valve, wherein the actuating valve is preferably a pulse-controlled solenoid valve.

It is further advantageous if the main valve is able to be actuated by the actuating valve indirectly via a piston system, wherein the piston system preferably has a control piston with a ram and a pressure member.

It is further preferred if the control piston, on actuation of the actuating valve, is subjected to pressure on a pressure side, in particular by opening of a feed line by the actuating valve.

It is further advantageous if the main valve has a closing member which is subjected to force by the pressure member of the piston system against a preferably conical valve seat, whereby the main valve is closed in the unactuated state, wherein the pressure member is preferably pushed/urged by a spring in the direction towards the valve seat.

It is further advantageous if the actuating valve is able to be actuated pneumatically, electrically (for example by a switching pulse of about 24 V) or by external control.

According to a further embodiment of the present disclosure, the valve assembly has a check valve which is disposed in the feed line for supplying the piston system with compressed air/control air before the actuating valve in the direction of flow and which prevents the compressed air/control air present at the control piston from escaping.

It is further preferred that a size of the piston area of the control piston is chosen such that the main valve remains in the open position even if the pressure on the pressure side of the control piston falls to a predetermined minimum pressure as a result of, for example, a leakage or a failure of the actuating valve. In other words, the piston force generated, which acts on the pressure member via the plunger, is greater than the opposing spring force/closing force even at the predetermined minimum pressure.

It is likewise advantageous if the valve assembly has a release valve, which is preferably a needle valve, a ball valve or a slowly opening valve, which is adapted, on actuation, in particular manual actuation, to reduce (again) the pressure present on the pressure side of the control piston, in particular after actuation of the actuating valve, whereby the main valve is able to return to the closed state.

### BRIEF DESCRIPTION OF THE SEVERAL VIEWS OF THE DRAWINGS

Further features and advantages of a device, a use and/or a method will become apparent from the following description of embodiments with reference to the accompanying drawings. In the drawings:

FIG. 1 is a perspective view of a high-pressure vessel unit according to the prior art,

FIG. 2 is a diagram of a fuel supply system according to the prior art,

FIG. 3 shows, in simplified form, an embodiment of a valve unit according to the disclosure,

FIG. 4 shows a pipeline and instrument flow diagram of an embodiment of a valve unit according to the disclosure,

FIG. 5 shows, in simplified form, an embodiment of a gas pressure tank system according to the disclosure,

FIG. 6 shows a further embodiment of a valve unit according to the disclosure, wherein the valve unit shown is a further development of the valve unit shown in FIGS. 3 to 5,

FIG. 7 is a perspective view, in schematic form, of an embodiment of a gas pressure tank system according to the disclosure,

FIG. 8 is a perspective view, in schematic form, of a further embodiment of a gas pressure tank system according to the disclosure, and

FIG. 9 is a sectional view of a further embodiment of a valve unit according to the disclosure.

### DETAILED DESCRIPTION

Identical reference numbers which are given in different figures denote identical, mutually corresponding or functionally similar elements.

FIG. 1 is a perspective view of a high-pressure vessel unit 10 according to the prior art. The high-pressure vessel unit 10 shown has a box-like case 22, a plurality of cylindrical vessels 18 which are disposed in a row inside the case 22, wherein each vessel 18 includes an opening 30B at an end portion on one side in the axial direction, a coupling member 20 which connects the openings 30B in order to couple the plurality of vessels 18 with one another, and which includes a flow passage which connects the interiors of the plurality of vessels 18 with one another so that they communicate. The described high-pressure vessel unit 10 further has a lead-out pipe 32 which leads from the coupling member 20 through a through-hole 46A formed in the case 22 to the exterior of the case 22, wherein there is connected to the lead-out pipe 32 a valve 34 which is able to open and close the flow passage.

As described, the high-pressure vessel unit 10 shown can close the respective vessels 18 (gas pressure tanks) not separately but only together via the valve 34, in the event of a leakage/defect of a vessel 18 and/or of a coupling member 20 the entire high-pressure vessel unit 10 accordingly fails.

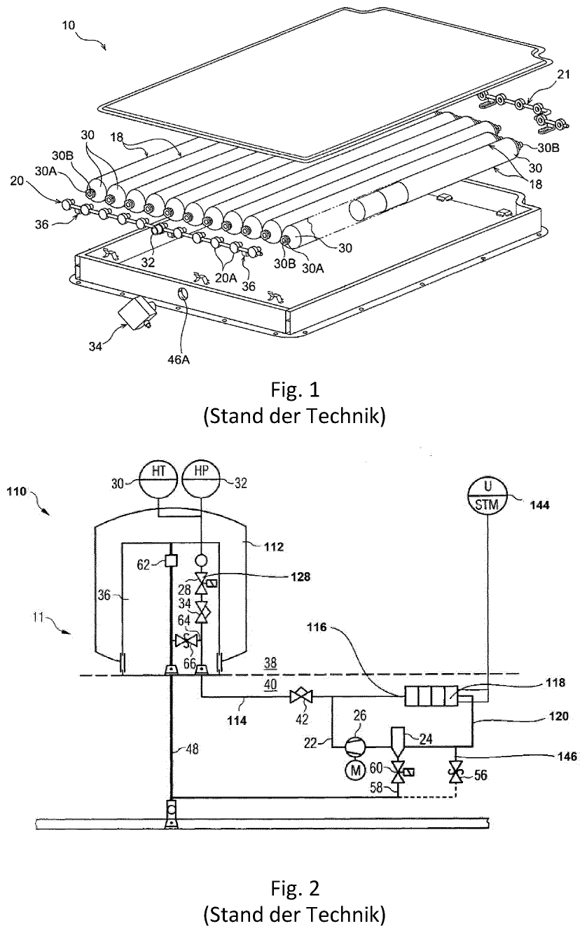

FIG. 2 further shows a diagram of a fuel supply system 110 according to the prior art, which can be used, for example, in an aircraft. The described fuel supply system 110 has a fuel tank 112, a feed line 114 which connects the fuel tank 112 to an inlet 116 of a fuel cell 118, a tank isolation valve 128 disposed in the feed line 114, a removal line 146 which connects an outlet 120 of the fuel cell 118 to an unpressurized region of the aircraft and/or the outer atmosphere, and a sensor 144 for detecting an electrical voltage in the fuel cell 118.

Although it is here possible to shut off, as it were to isolate, the single fuel tank 112 by means of the tank isolation valve 128, the tank isolation valve 128 is not installed directly on the fuel tank 112, whereby, in the event of a leakage between the fuel tank 112 and the tank isolation valve 128, there is no possibility of closing the gas leak by closing the tank isolation valve 128. After the tank isolation valve 128 has been closed, it is also not possible to give information about the integrity of the fuel tank 112 and the connecting pipeline.

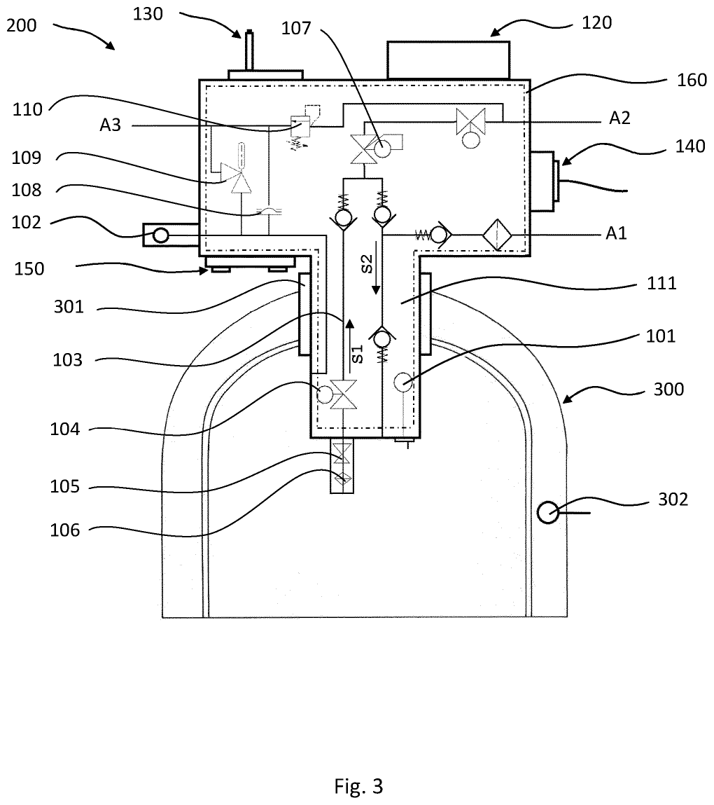

FIG. 3 further illustrates, in simplified form, an embodiment of a valve unit 100 according to the disclosure, which in the illustrated embodiment is implemented as an on-tank valve (OTV) 200, in particular as an OTV-R, that is to say an on-tank valve having a pressure regulating valve 107. As can be seen from FIG. 3, the on-tank valve 200 has a temperature detector 101 and a pressure detector 102. The temperature detector 101 is directly fastened to a connecting piece 111 of the on-tank valve 200, by means of which the on-tank valve is fastened to, in particular screwed into, a gas pressure tank 300. The temperature detector 101 is provided at the end of the connecting piece 111 that projects into the gas pressure tank 300. Accordingly, the temperature detector 101 is in direct contact with the fuel stored in the gas pressure tank 300.

The pressure detector 102, on the other hand, is accommodated in an external component which is connected to, in particular screwed to, the on-tank valve 200 in a gas-tight manner. The pressure detector 102 is in contact with the stored fuel (fuel gas or hydrogen) via an independent fluid line, which extends at least in part through the connecting piece 111. Accordingly, the pressure detector 102 is able to directly detect or measure the pressure prevailing in the gas pressure tank 300 (gas pressure tank pressure P₁).

The illustrated on-tank valve 200 further has a safety valve 104 integrated into a line section 103, wherein the safety valve 104, which is preferably pulse-controlled, can be adjusted between an open position, in which gas is able to flow through the line section 103, and a closed position, in which gas is not able to flow through the line section 103. In the embodiment shown, the line section 103 serves to provide the fuel stored under high pressure (up to 900 bar) in the gas pressure tank 300 via a supply port A2 to a downstream consumer (not shown).

As can be seen from FIG. 3, the temperature detector 101 and the pressure detector 102 are so disposed that they are able to detect a temperature and a pressure of the gas flowing through the line section 103 in a state in which the gas is present at the closed safety valve 104 in such a manner that it exerts pressure. In other words, the two detectors, which are configured as sensors, can directly detect the temperature and the pressure of the fuel confined in the gas pressure tank by the safety valve 104.

If the safety valve 104 is opened, the fuel stored in the gas pressure tank under high pressure, about 350 bar, 700 bar, 875 bar or 900 bar, flows via the line section 103 in the direction towards the supply port A2, whereby the stored fuel is provided to a downstream consumer. Before it reaches the safety valve 104, the stored fuel first flows through a filter 106 in order to remove contaminants present in the stored fuel. The fuel then flows through an excessive flow valve 105, whereby the maximum flow of the fuel flowing out of the gas pressure tank 300 is limited, in particular is limited such that the maximum flow is determined so as to be slightly higher than the maximum flow required by the connected consumer.

In this manner, on the one hand a sufficiently great fuel flow for supplying the downstream consumer or the downstream consumers is ensured, on the other hand the flow is limited as far as possible so that an undesirably large amount of fuel does not escape in the event of a fault.

After the safety valve 104 in the direction of flow S1 there is provided in the line section 103 the pressure regulating valve 107, which reduces and/or regulates the gas pressure introduced by the gas pressure tank 300 (gas pressure tank pressure P₁) to an operating pressure P₂ which is preset or adapted to the operating load of the downstream consumer.

Between the safety valve 104 and the pressure regulating valve 107 there is disposed a check valve such that a return flow from the pressure regulating valve 107 in the direction towards the safety valve 104 is prevented.

Furthermore, in the illustrated embodiment, a further, preferably magnetic, safety valve is disposed after the pressure regulating valve 107, wherein it is possible by means of this safety valve to block or confine the fuel already reduced to the operating pressure P₂ in the valve unit 100, in particular the on-tank valve 200, and to run the consumer, for example a fuel cell system, disposed thereafter empty. In other words, to remove the fuel from the fuel cell system and thus reduce the pressure that is present. It is further advantageous if the further safety valve is configured such that it is able to open only up to a predetermined pressure, such as, for example, 50 bar, that is to say a pressure which on the one hand is lower than the maximum pressure of 350 bar, 700 bar, 875 bar or 900 bar prevailing in the gas pressure tank 300 and on the other hand is greater than the operating pressure P₂ required by the downstream consumer.

The illustrated on-tank valve 200 further has a first excess pressure device 110 in the form of an excess pressure valve, which in the embodiment shown is set to a pressure of 19 bar, thus the operating pressure P₂ present at the downstream consumer is limited to 19 bar. If the pressure regulating valve 107 has a fault and reduces, for example, the pressure of the fuel only to 50 bar, the excess pressure valve 110 opens and discharges the excess fuel to the environment via the discharge port A3.

As can further be seen from FIG. 3, the illustrated on-tank valve 200 further has a second excess pressure device 108 which is configured as a rupture disk and is adapted to protect the gas pressure tank 300 connected to the on-tank valve 200 from excess pressure.

The on-tank valve 200 further has a thermal pressure relief device 109 which is adapted to open at a predetermined temperature limit value, that is to say to open a valve of the pressure relief device 109 that is closed by default, in order to release the fuel stored in the gas pressure tank 300 to the environment via the discharge port A3. The pressure relief device 109 is configured such that the fuel cannot escape too quickly, in order to protect the gas pressure tank 300 from damage, but nevertheless to allow the fuel to escape at a sufficiently high speed, generally within from 3 to 5 minutes, so that the integrity of the gas pressure tank 300 can be ensured until it is completely empty.

The pressure relief device 109 can be disposed, as shown in the illustrated embodiment, parallel to the second excess pressure device 108 (rupture disk) and the pressure detector 102 in a fluid line which connects the discharge port A3 to the interior (storage chamber) of the gas pressure tank 300 so as to carry fluid. The pressure relief device 109 can further be irreversibly actuated, that is to say opened, by rupturing of a glass body, wherein the rupturing of the glass body is so set that rupturing occurs at a predetermined temperature and optionally only after the predetermined temperature has been present for a specified time period. It is advantageous for safety reasons if the actuation or triggering of the pressure relief device takes place irreversibly, in order that undesirable closing can be ruled out after the pressure relief device has been actuated or triggered once. Actuation of the pressure relief device can, however, also take place by an external pulse or by activation.

As is further shown in FIG. 3, the illustrated on-tank valve has a control device 120 which can serve to evaluate and optionally to log the values detected by the detectors 101 and 102 and to determine a state of integrity of the gas pressure tank 300 and of the on-tank valve 200 on the basis of the detected values. The control device 120 is further adapted to control a fuel supply operation of the downstream consumer, in particular to correspondingly open or close the pressure regulating valve 107, on the basis of the detected values. In order to be able to establish different pressures, the pressure regulating valve can also be partially opened or closed, so that degrees of opening of between 0% and 100% are likewise possible.

The on-tank valve 200 illustrated in FIG. 3 further has a communication device which has, for example, a Bluetooth and a WLAN antenna, by means of which the on-tank valve 200 can communicate wirelessly with external clients. The on-tank valve shown further has a leakage detection unit as already described in detail above.

Finally, the on-tank valve 200 shown has a refueling port (filling port) A1, by means of which the gas pressure tank can be filled with gas, in particular fuel. For this purpose, the illustrated on-tank valve 200 has a separate refueling channel in which the fuel introduced is guided in the direction of flow S2 into the gas pressure tank 300. In the refueling channel there is again provided a filter in order to prevent contaminants present in the fuel to be introduced from entering the gas pressure tank 300 and accumulating therein. After the filter in the flow direction S2 there is further disposed a check valve or a plurality of check valves connected one after the other, which prevent(s) the fuel introduced from flowing back to the filter. A further check valve is further provided at the end of the refueling channel facing the gas pressure tank 300, which prevents the fuel introduced from escaping via the refueling port A1.

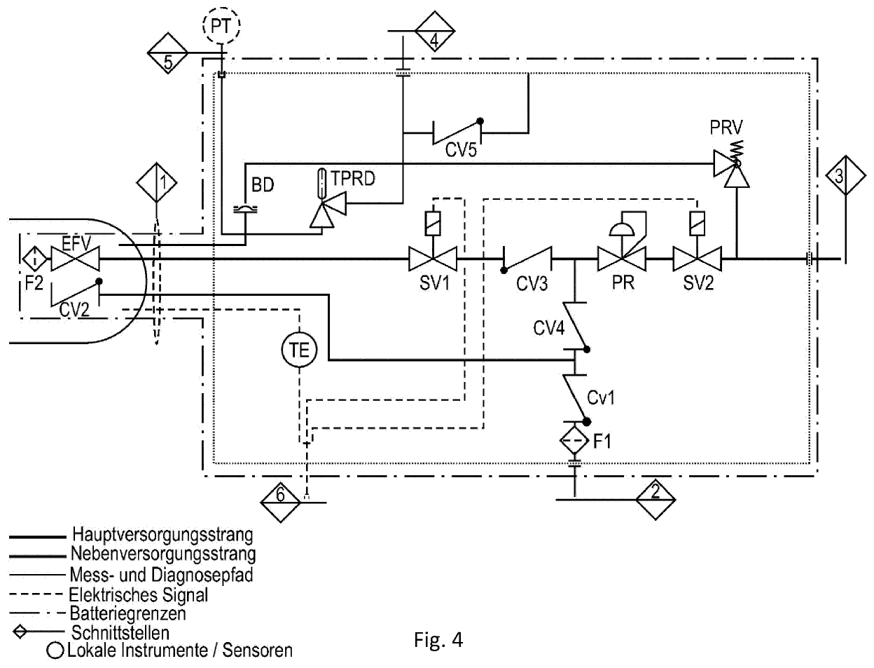

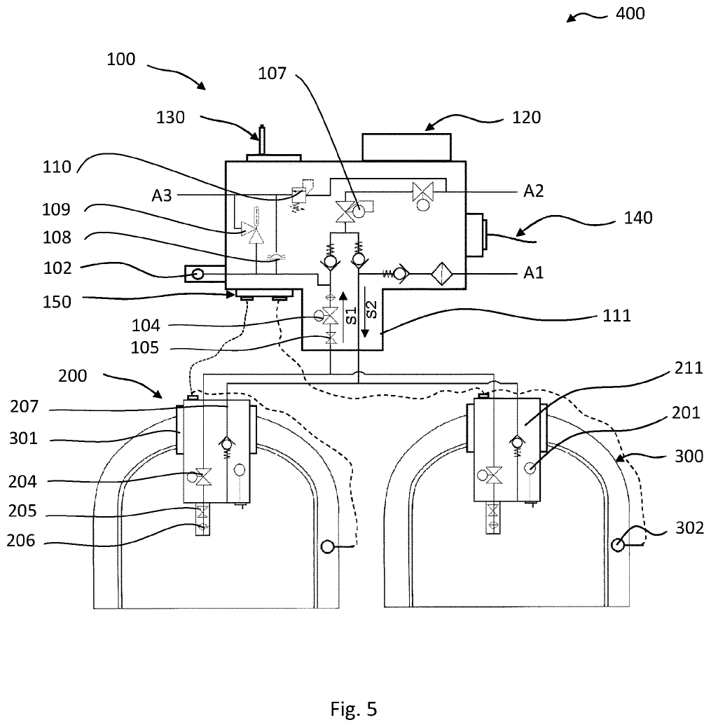

FIG. 4 shows a pipeline and instrument flow diagram of an embodiment of a valve unit 100 according to the disclosure, wherein the illustrated valve unit 100 corresponds in terms of its fundamental construction to the on-tank valve 200 illustrated in FIG. 3.

As can be seen from FIG. 4, the valve unit 100, in particular gas handling unit, shown has six interfaces with which the valve unit 100 can be connected to external components, in particular can be connected so as to carry fluid. The interface 1, for example, serves to connect a single gas pressure tank 300 or a gas pressure tank system 400 to the valve unit 100. Accordingly, the interface 1 has a feed line (secondary supply line) via which the gas pressure tank 300 can be filled with fuel, a main supply line via which the fuel stored under high pressure in the gas pressure tank 300 can be fed to a consumer, and two measurement and diagnosis paths. The first measurement and diagnosis path connects the interior (fuel filling) of the gas pressure tank 300 to a temperature element (temperature detector 101) which is provided in the valve unit and by means of which the temperature of the fuel in the gas pressure tank 300 can be detected. The second measurement and diagnosis path is divided between three paths/lines arranged in parallel, on one of the three paths there is formed on the one hand an interface 5 to which an exchangeable/mountable pressure sensor element (pressure detector 102) is connected. The pressure sensor element connected to the interface 5 detects the pressure inside the gas pressure tank 300 via the second measurement and diagnosis path. In a second path there is disposed a rupture disk (excess pressure device 108) which protects the connected gas pressure tank 300 from excess pressure. In other words, if, for example during filling of the gas pressure tank, the pressure inside the gas pressure tank 300 reaches a predetermined limit value, for example 900 bar, as a result of a faulty refueling system, the rupture disk breaks and thereby opens the access to the interface 4 (discharge port A3), via which the fuel can be discharged to the surrounding air.

At the third path there is provided a thermal pressure relief device (TPRD) which, when a predetermined limit value/maximum temperature is reached, for example in the event of an accident resulting in a fire, likewise opens an access to the interface 4 (discharge port A3), whereby the fuel stored in the gas pressure tank 300 can be discharged/released to the environment in a controlled manner. A channeled release to the environment can take place. This is to be understood as meaning that the direction of release is chosen such that the outflowing fuel is released in a direction in which no components and/or persons are endangered.

As can further be seen from FIG. 4, there are disposed inside the gas pressure tank 300 a filter F2, a check valve CV2 and an excessive flow valve EFV, the function of which has already been described in connection with FIG. 3.

There are disposed in the main supply line, in the direction of flow to an interface 3 to which a downstream consumer such as, for example, a fuel cell system can be connected, a safety valve SV1, a check valve CV3, a pressure regulating valve PR and a further safety valve SV2, wherein the two safety valves are configured as solenoid valves.

There is further connected, after the second safety valve SV2 in the direction of flow, an excess pressure device PRV which triggers when a preset maximum pressure, which is so chosen that the downstream consumer cannot be damaged, is reached and in the actuated state opens an access to the interface 4 (discharge port A3), whereby the excess fuel can be released to the outside.

The valve unit 100 shown additionally has an interface 2 via which, for example, a refueling system can be connected to the valve unit 100 for filling the gas pressure tank 300. A filter F1, a check valve CV1 and the check valve CV2 provided in the gas pressure tank 300 are disposed in the direction of flow from the interface 2 to the interface 1, to which the gas pressure tank 300 is connected. The feed line (secondary supply line) is advantageously connected via a check valve CV4 to the main supply line, in particular between the check valve CV3 and the pressure regulating valve PR.

Interface 6 illustrates a signal connection by means of which the safety valves SV1 and SV2, the pressure regulating valve PR and the sensor elements PT, TE can be connected to a control unit, wherein the control unit can also be integrated into the valve unit 100.

FIG. 5 shows, in simplified form, an embodiment of a gas pressure tank system 400 according to the disclosure, which consists by way of example of two gas pressure tanks 300, two on-tank valves 200, each of which is screwed into a gas pressure tank 300, and a valve unit 100, which is configured as a gas handling unit. The gas handling unit comprises all the components or associated functions described in relation to the on-tank valve 200 shown in FIG. 3.

The two illustrated on-tank valves 200, on the other hand, are limited to minimally necessary safety functions. For example, the two on-tank valves 200 each have a safety valve 204 by means of which an undesired outflow of the fuel from the individual gas pressure tanks 300 can be prevented, in particular in the event of an accident. Accordingly, the protection valves 204, like the protection valve 104 of the gas handling unit 100, are self-closing valves. The on-tank valves 200 further each comprise an excessive flow valve 206 which is adapted to limit the outflow of the fuel to a predetermined maximum value. The on-tank valves 200 further have a refueling channel 207 which is provided with a check valve. A filter 205 is further disposed before the safety valve 204, in particular before the excessive flow valve 206. Finally, the two on-tank valves 200 also have a temperature and/or pressure detecting unit 201.

The gas handling unit 100 disposed downstream of the on-tank valves 200 in the outflow direction S1 likewise has an excessive flow valve 106 which serves to limit the flow of fuel accumulated by the plurality of connected gas pressure tanks 300 (here two). The gas handling unit 100 further has a connection region 150 by means of which the two on-tank valves 200 are electrically and electronically connected to the gas handling unit 100, in particular the control unit 120 thereof. In this manner, the control unit 120 can access the values or data determined by means of the temperature and/or pressure detecting unit 201 and if necessary actuate the safety valves 204 accordingly.

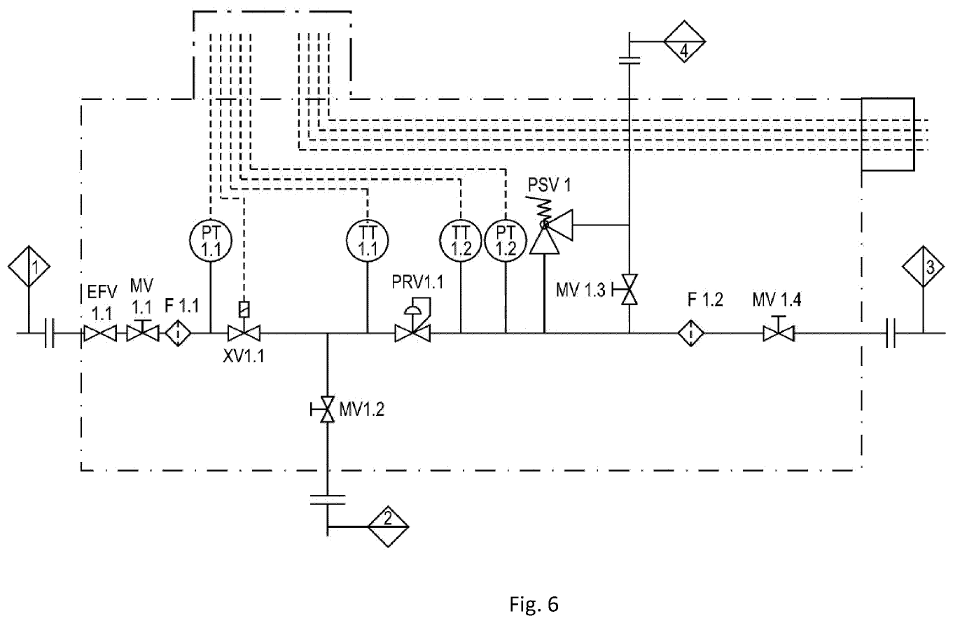

FIG. 6 shows a pipeline and instrument flow diagram of a further embodiment of a valve unit 100 according to the disclosure, wherein the valve unit shown is a further development of the valve unit shown in FIGS. 3 to 5. The valve unit shown in FIG. 6 likewise has the interfaces 1 to 4, only the interfaces 5 (pressure detector 102) and 6 (signal connection) are absent. This is because the control device 120 and the pressure detector 102 are integrated directly into the valve unit 100.

As can be seen from FIG. 6, in the illustrated embodiment of the valve unit 1, in the direction of flow from the interface 1 to the interface 3, to which a consumer can likewise be connected, there are in the main supply line an excessive flow valve EFV1.1, a first manual valve (safety valve) MV1.1, a filter F1.1, a solenoid valve XV 1.1, a pressure regulating valve PRV1.1, a second filter F1.2 and a second manual valve MV1.4. Here too, as in FIG. 4, an excess pressure device PSV1 is provided after the pressure regulating valve PRV1.1, which can release excess fluid to the outside via the interface 4.

The major difference relative to the valve unit described in FIG. 4 is on the one hand that not only are a pressure sensor PT1.1 and a temperature sensor TT1.1 provided before the pressure regulating valve PRV1.1, but a pressure sensor PT1.2 and a temperature sensor TT1.2 are also provided after the pressure regulating valve PRV1.1 in the direction of flow. This configuration is advantageous in particular when the valve unit 100 has a temperature-control device 170. In this case, the state (temperature and pressure) of the fuel after pressure reduction has been carried out by the pressure regulating valve PRV1.1 can be detected by means of the second sensor pair PT1.2, TT1.2, and the temperature-control device 170 can be controlled accordingly. In this manner it is possible to optimally condition the fuel for the following consumer. Furthermore, the state information additionally determined can be used for conducting the tightness test. In this manner, the tightness test, in particular the tightness test of the gas pressure tank 300 and/or of the gas pressure tank system 400, can be conducted more reliably in particular during operation of the downstream consumer, in particular of the fuel cell system, that is to say while the fuel stored in the gas pressure tank 300 is continuously flowing out.

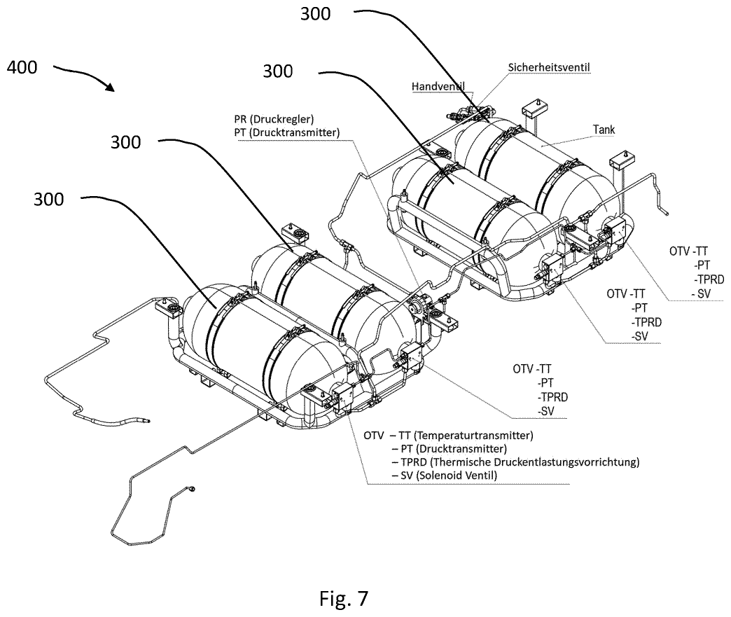

FIG. 7 is a perspective view, in schematic form, of an embodiment of a gas pressure tank system 400 according to the disclosure. The illustrated gas pressure tank system 400 consists of four gas pressure tanks 300 disposed side by side, each of which is provided with an on-tank valve 200 (OTV), which are in turn connected to one another via a fluid line.

As can be seen from FIG. 7, the four on-tank valves 200 (OTVs), which are attached to the front side of the gas pressure tanks 300, each have a thermal pressure relief device (TPRD), a temperature and a pressure detector (TT, PT) and a solenoid valve (SV). The four on-tank valves 200 are further connected via lines to a common pressure regulating valve, which reduces the pressure in the gas pressure tanks 300 to an operating pressure. After the pressure regulating valve (PR), which likewise has a pressure detector (PT), the channeled fuel is guided via a line to a manual valve, which is coupled with a safety valve. The four gas pressure tanks are further channeled to a feed line, via which the four gas pressure tanks 300 can be refueled or filled. The discharge outlets of the four thermal pressure relief devices (TPRDs) are likewise channeled in order to allow the fuel which flows out in an emergency to flow out via a common line in a channeled and directed manner, in particular in a required direction.

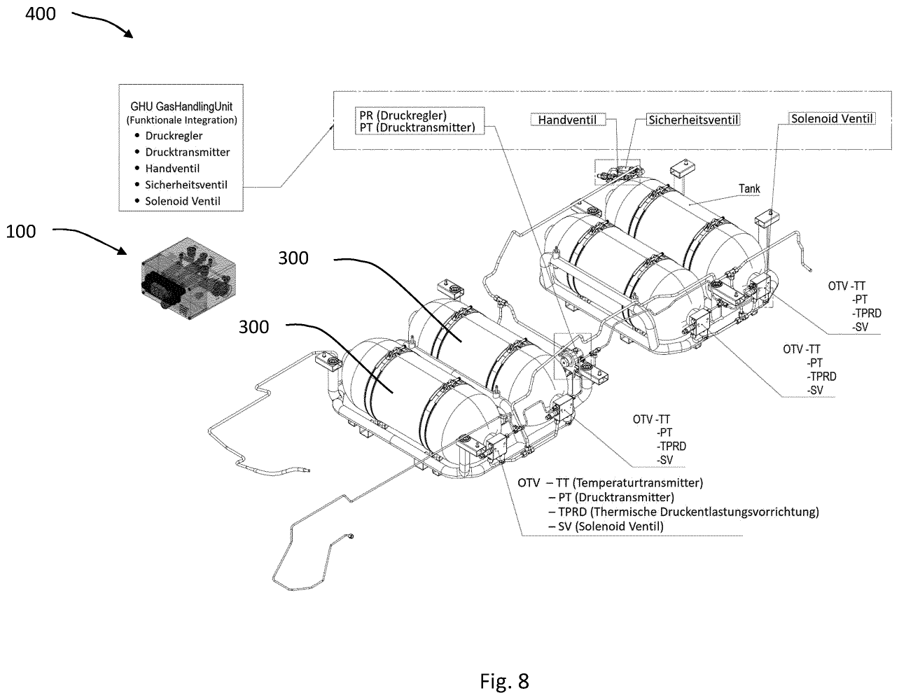

FIG. 8 is a perspective view, in schematic form, of a further embodiment of a gas pressure tank system 400 according to the disclosure. The illustrated gas pressure tank system 400 has in principle the same components as the gas pressure tank system 400 illustrated in FIG. 7. However, the gas pressure tank system 400 illustrated in FIG. 8 differs in that a plurality of components that are relevant in terms of safety, which were configured separately in the gas pressure tank system 400 of FIG. 7, are integrated in a unit, namely in a gas handling unit 100. In the illustrated embodiment, the pressure regulating valve (PR), the manual valve and the safety valve are integrated in the gas handling unit. In addition, the solenoid valves (SV) provided in FIG. 7 in each of the on-tank valves 200 (OTVs) are realized in the gas handling unit 100 as a single solenoid valve (SV). In this manner it is possible on the one hand to integrate the individual components in a compact manner in a valve block, and on the other hand to reduce the outlay in terms of cabling and piping and thus the costs and the outlay in terms of maintenance.

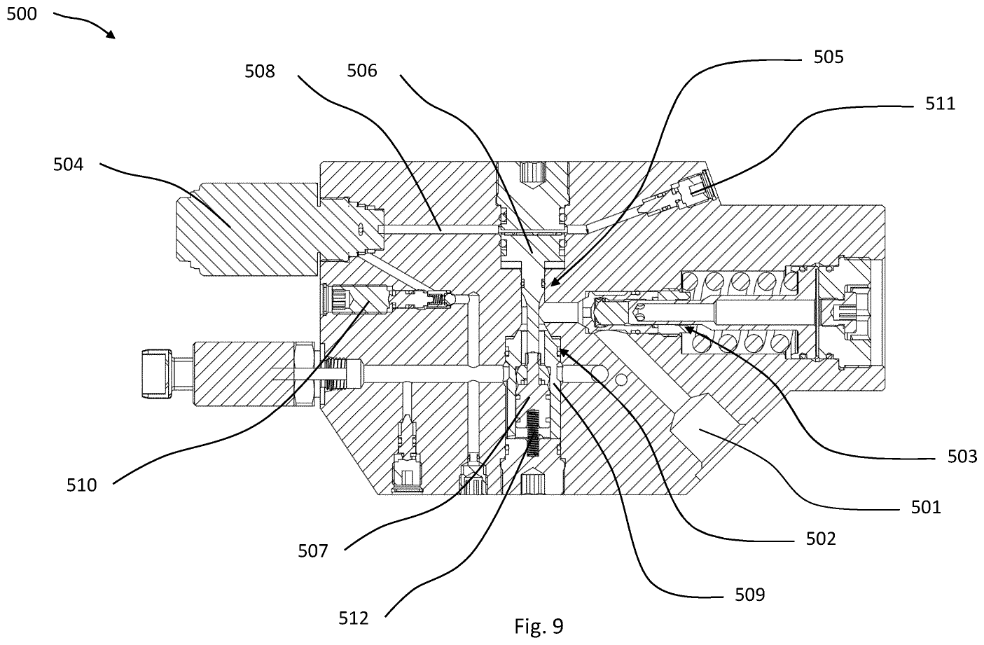

FIG. 9 is a sectional view of a further embodiment of a valve unit 100 according to the disclosure. FIG. 9 is in principle to illustrate the concrete implementation of a main valve which is preferably used in valve units which are used, for example, for fire extinguishing systems which preferably use nitrogen as the extinguishing agent.

As can be seen from FIG. 9, the valve assembly 500 of such a valve unit has a main supply line 501, a main valve 502 integrated into the main supply line, wherein the main valve is adjustable between an open position, in which gas is able to flow through the main supply line 501, and a closed position, in which gas is not able to flow through the main supply line 501, and a pressure regulating valve 503 which is adapted to reduce and/or to regulate a pressure of the gas flowing through the main supply line. The main valve 502 is able to be actuated indirectly by means of a pulse-controlled actuating valve 504, which is configured as a solenoid valve, via a piston system 505, wherein the piston system 505 has a control piston 506 with a plunger and a pressure member 507.

If the actuating valve 504 is actuated, it opens a feed line 508 via which the control piston 506, in particular a pressure side of the control piston, is supplied with or subjected to compressed air or control air. A check valve 510 is disposed before the actuating valve 504 in the direction of flow of the compressed or control air, which, even when the actuating valve is actuated for only a short time or triggers as a result of a defect, prevents that the pressure present on the pressure side of the control piston falls.

As can further be seen from FIG. 9, in a closed position of the main valve 502 the pressure member 507 of the control piston 506 is urged by the force of a spring 512 in the direction towards the control piston 506, in particular in the direction towards a valve seat, whereby a closing member 509 of the main valve 502 is pressed into the valve seat by the pressure member 507 and the main valve 502 is moved into the closed state.

If the actuating valve 504 is now actuated, and if compressed air or control air is present on the pressure side of the control piston 506, the control piston is pushed in the direction towards the main valve 502, in particular towards the closing member 509 of the main valve 502, and, because the piston force generated by the control piston 506 is greater than the spring force of the spring 512, the plunger of the control piston 506 pushes the pressure member 507 against the spring 512, whereby the closing member 509 is freed and pushed away from the valve seat by the pressure exerted by the gas (useful gas). The main valve 502 is in the open position.

The valve assembly 500, in particular a size of the piston area of the control piston 506, is chosen such that the main valve 502 remains in the open position even if the pressure on the pressure side of the control piston falls to a predetermined minimum pressure, which can occur, for example, as a result of a leakage and failure of the actuating valve. In other words, the piston force which is generated and which acts on the pressure member via the plunger is greater than the opposing spring force/closing force even at the predetermined minimum pressure.

If the main valve 502 is intentionally to be released, a release valve 511 is to be actuated manually. If the release valve 511 is actuated, the pressure present on the pressure side of the control piston is reduced, whereby the main valve 502 returns to the closed state.

It is clear to the person skilled in the art that individual features each described in different embodiments can also be implemented in a single embodiment, provided that they are not structurally incompatible. Equally, different features which are described within the scope of a single embodiment can also be provided in a plurality of embodiments individually or in any suitable subcombination.

### LIST OF REFERENCE NUMBERS

100 valve unit
101 temperature detector
102 pressure detector
103 line section
104 safety valve
105 excessive flow valve
106 filter
107 pressure regulating valve
108 second excess pressure device
109 thermal pressure relief device
110 first excess pressure device/excess pressure valve
111 connecting piece
120 control device
130 communication device
140 electrical and/or electronic interface
150 connection region
160 leakage detecting unit (sniffer)
170 orientation detecting unit
180 temperature-control device
200 on-tank valve
201 temperature and/or pressure detector
204 safety valve
205 excessive flow valve
206 filter
207 refueling channel
211 connecting piece
300 gas pressure tank
301 connecting piece
302 temperature sensor
400 gas pressure tank system
500 valve assembly
501 main supply line
502 main valve
503 pressure regulating valve
504 actuating valve
505 piston system
506 control piston
507 pressure member
508 feed line
509 closing member
510 check valve
511 release valve
512 spring

The present application claims priority to International Patent Application No. PCT/EP2021/065626 filed on Jun. 10, 2021 and German Patent Application No. 10 2020 207 253.1 filed on Jun. 10, 2020, the entire contents of which are incorporated herein by reference in their entirety.

In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A valve unit which is usable for a fuel supply system or a fire extinguishing system, comprising:
at least one temperature detector,
at least one pressure detector, and
a safety valve integrated into a line section, wherein the safety valve can be adjusted between an open position, in which gas is able to flow through the line section, and a closed position, in which gas is not able to flow through the line section,
wherein
the temperature detector and the pressure detector are so disposed that they are able to detect a temperature and a pressure of the gas flowing through the line section in a state in which the gas is present at the closed safety valve in such a manner that it exerts pressure, and
the valve unit is further adapted to conduct a tightness test of the line section of a gas pressure tank system connected to the line section, on the basis of the detected temperature and pressure values in the closed state of the safety valve.

2.-4. (canceled)

5. The valve unit according to claim 1, wherein an excessive flow valve or throttle valve is provided before the safety valve in a direction of flow of the gas or fuel from the gas pressure tank towards a consumer, and
wherein the valve unit further includes a pressure regulating valve which is disposed after the safety valve in the direction of flow and is adapted to reduce or to regulate, or both, a gas pressure tank pressure to an operating pressure of a consumer that is to be supplied with the fuel.

6. The valve unit according to claim 1, further having an excess pressure device which is adapted to limit the operating pressure regulated by the pressure regulating valve to a preset limit value or to protect a gas pressure tank connected to the valve unit from excess pressure.

7. (canceled)

8. The valve unit according to claim 1, further having a thermal pressure relief device which is adapted, at a predetermined temperature limit value, to release the fuel stored under pressure in a gas pressure tank connected to the valve unit to the surrounding air via a discharge port.

9. (canceled)

10. The valve unit according to claim 1, further having a control device which is adapted to receive measurement signals of at least one of the temperature detector, the pressure detector, external sensors, and a temperature sensor provided on a gas pressure tank, to process those signals and to output corresponding control signals to at least one of the safety valve, the pressure regulating valve, and the thermal pressure relief device.

11. The valve unit according to claim 10, wherein the control device is adapted, in order to conduct a tightness test of the line section of a gas pressure tank system connected to the line section, to bring the safety valve into a closed position and then, for a predetermined time period, to determine a plurality of temperature and pressure values of the gas or fuel present at the safety valve via the temperature detector and the pressure detector, and to conduct the tightness test on the basis of the determined temperature and pressure values.

12.-16. (canceled)

17. The valve unit according to claim 10, further comprising a temperature-control device which is adapted to condition the fuel flowing through the valve unit after it has been reduced to the operating pressure by the pressure regulating valve, to a predetermined operating temperature.

18. (canceled)

19. The valve unit according to claim 1, further comprising a leakage detection unit which is adapted to test the tightness of at least one component of the valve unit, wherein the component is selected from the group of: safety valve, excessive flow valve, filter, pressure regulating valve, first excess pressure device, second excess pressure device, thermal pressure relief device, temperature-control device, temperature detector, and pressure detector.

20. The valve unit according to claim 1, further comprising an orientation detection unit which is adapted to detect the absolute geometric orientation in space of the valve unit of the at least one gas pressure tank connected to the valve unit, wherein the orientation detection unit has at least one sensor selected from the group of:
accelerometer, gyroscope and geomagnetic sensor.

21. (canceled)

22. (canceled)

23. The valve unit according to claim 1, further comprising a power generation device comprising:
a converter which is adapted to convert flow energy of the fuel flowing into the valve unit, into mechanical energy, and
a generator which is adapted to convert the mechanical energy into electrical energy.

24.-29. (canceled)

30. A method for detecting a possible leakage in a fuel supply system including a gas pressure tank system for storing fuel, which is adapted to supply a fuel cell system with fuel, comprising the steps of:
closing a safety valve integrated into a line section, wherein the safety valve can be adjusted between an open position, in which gas is able to flow through the line section, and a closed position, in which gas is not able to flow through the line section,
detecting a temperature and a pressure of the gas flowing through the line section in a state in which the gas is present at the closed safety valve in such a manner that it exerts pressure,
conducting a tightness test of the line section of a gas pressure tank system connected to the line section, on the basis of the detected temperature and pressure values.

31. The method according to claim 30, wherein a plurality of temperature and pressure values are determined within a predetermined time period, wherein the temperature and pressure values are determined inside a connected pressure tank or at a plurality of measurement points inside a connected gas pressure tank system, or both.

32. The method according to claim 31, wherein the plurality of determined temperature and pressure values are compared with one another in order to determine a characteristic value of the stability or a trend, or both, if the characteristic value of the stability or the trend, or both lies within a predetermined range, the line section of the gas pressure tank system connected to the line section, is tight.

33. (canceled)

34. A valve assembly of a valve unit, which is used for a fire extinguishing system which uses nitrogen as the extinguishing agent, comprising:
a main supply line,
a main valve integrated into the main supply line, wherein the main valve is adjustable between an open position, in which gas is able to flow through the main supply line, and a closed position, in which gas is not able to flow through the main supply line, and
a pressure regulating valve which is adapted to reduce or to regulate, or both, a pressure of the gas flowing through the main supply line,
wherein the main valve is able to be brought or switched indirectly into the open position by a pulse-controlled actuating valve, wherein the valve assembly is configured such that the main valve remains in the open position even if actuation by the pulse-controlled actuating valve is released or interrupted, or both.

35. The valve assembly according to claim 34, wherein the main valve is able to be brought into the open position by manual actuation of the pulse-controlled actuating valve, wherein the actuating valve is a pulse-controlled solenoid valve.

36. The valve assembly according to claim 34, wherein the main valve is able to be actuated by the actuating valve indirectly via a piston system, wherein the piston system has a control piston with a plunger and a pressure member.

37. (canceled)

38. The valve assembly according to claim 34, wherein the main valve has a closing member which is subjected to force by the pressure member of the piston system against a conical valve seat, whereby the main valve is closed in the unactuated state, wherein the pressure member is pushed by a spring in the direction towards the valve seat.

39. (canceled)

40. The valve assembly according to claim 34, further having a check valve which is disposed in the feed line for supplying the piston system before the actuating valve in the direction of flow and which prevents the compressed air or control air, or both, present at the control piston from escaping.

41. The valve assembly according to claim 34, wherein a size of the piston area of the control piston is chosen such that the main valve remains in the open position even if the pressure on the pressure side of the control piston falls to a predetermined minimum pressure as a result of leakage or failure of the actuating valve.

42. The valve assembly according to claim 34, further having a release valve that is at least one of a needle valve, a ball valve or a slowly opening valve, which is adapted, on actuation to reduce the pressure present on the pressure side of the control piston, whereby the main valve returns to the closed state.
